(19) United States
(12) Patent Application Publication
(10) Pub. No.: US 2023/0396419 A1
(43) Pub. Date: Dec. 7, 2023

(54) DATA ENCRYPTION KEY SPLITS

(71) Applicant: Hewlett-Packard Development Company, L.P., Spring, TX (US)

(72) Inventor: Alberto Such Vicente, Sant Cugat del Valles (ES)

(21) Appl. No.: 17/829,638

(22) Filed: Jun. 1, 2022

(51) Int. Cl. H04L 9/08; G06F 21/60

(52) U.S. Cl. CPC H04L 9/085; G06F 21/602; G06F 21/608

(57) ABSTRACT

The present disclosure describes a computing device to encrypt content with a data encryption key (DEK), split the DEK into a first DEK portion and a second DEK portion, upload encrypted content to a public database, provide the first DEK portion to a first type of device and the second DEK portion to a second type of device, and allow the second type of device to provide the second DEK portion to the first type of device when the first type of device is authorized to decrypt the content utilizing the first DEK portion and the second DEK portion.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring the computing device along while in a mobile setting. These computing devices can utilize encryption methods such that data can be transmitted with less risk of unwanted users obtaining the data.

### BRIEF DESCRIPTION OF THE DRAWINGS

FIG. 1 illustrates an example of a method for executing a data encryption key split.

FIG. 2 illustrates an example of a method for executing a data encryption key split.

FIG. 3 illustrates an example of a computing device for executing a data encryption key split.

FIG. 4 illustrates an example of a memory resource storing instructions for executing a data encryption key split.

FIG. 5 illustrates an example of a system including a computing device for executing a data encryption key split.

### DETAILED DESCRIPTION

A user may utilize a computing device for various purposes, such as for business and/or recreational use. As used herein, the term “computing device” refers to an electronic system having a processor resource and a memory resource. Examples of computing devices can include, for instance, a laptop computer, a notebook computer, a desktop computer, an all-in-one (AIO) computer, networking device (e.g., router, switch, etc.), and/or a mobile device (e.g., a smart phone, tablet, personal digital assistant, smart glasses, a wrist-worn device such as a smart watch, etc.), among other types of computing devices. As used herein, a mobile device refers to devices that are (or can be) carried and/or worn by a user.

Computing devices can be utilized with a plurality of peripheral devices and/or can be embedded within devices. For example, computing devices can utilize peripheral devices such as printing devices to generate images on a print media. In other examples, the computing devices can be communicatively coupled to a plurality of other computing devices through a network. Communication through a network can be intercepted by unauthorized parties. In order to protect data from being intercepted and utilized by unauthorized parties, the data can be encrypted with a data encryption key (DEK). As used herein, a data encryption key refers to a string of bits generated to scramble and unscramble data. That is, a data encryption key can be utilized to encrypt data such that the encrypted data can be transmitted or protected until it is decrypted to be utilized.

A plurality of different encryption techniques can be utilized with a data encryption key to encrypt and/or decrypt data. For example, attribute based encryption can be utilized to allow users with particular attributes to have access to the DEK for decrypting the encrypted data. Although specific examples are provided that utilize attribute based encryption, other types of encryption techniques can be utilized in a similar way. In some examples, encryption can be utilized for digital rights management solutions. As used herein, a digital rights management solution is a system or method for controlling and managing access to data. For example, a digital rights management solution can be utilized to control and manage access to copyright materials.

The present disclosure describes methods for encrypting data with a split data encryption key such that a first portion of the data encryption key can be provided to a first organization or first device and a second portion of the data encryption key can be provided to a second organization or second device. In this way, both the first organization and second organization can be prevented from viewing the data without both portions of the data encryption key. In some examples, the data can be encrypted utilizing a data encryption key by an owner of the data. The owner may wish to distribute the data through a digital rights management solution. In these examples, the data encryption key can be split into a first portion and a second portion. The first portion of the data encryption key can be provided to a crypto service and the second portion of the data encryption key can be provided to a device such as a printing device. In these examples, the crypto service can authenticate a user wanting to access the data and can provide the first portion of the data encryption key to the device such that the device can decrypt the data with the first portion and the second portion. In these examples, the first portion of the DEK can represent a first portion of bits of the string of bits associated with the DEK and the second portion of the DEK can represent a remaining portion of bits of the string of bits associated with the DEK. In this way, the combination of the first portion and the second portion can represent the complete string of bits associated with the DEK.

Although specific examples describe that the DEK can be split or broken into a first portion and a second portion, in other examples, the DEK can be split into a plurality of additional portions. For example, the DEK can be split into a plurality of additional portions to the first portion and the second portion. In a specific example, the DEK can be split into four separate portions. The four separate portions can be provided to different users and/or a first quantity of portions can be provided to a first user and a second quantity of portions can be provided to a second user.

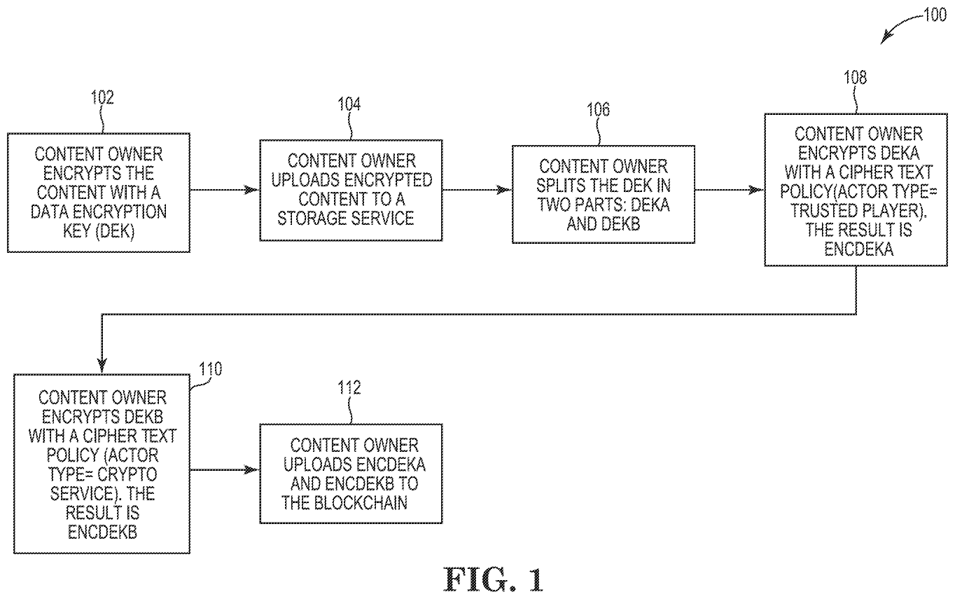

FIG. 1 illustrates an example of a method 100 for executing a data encryption key split. In some examples, the method 100 can be performed or executed by a computing system. In some examples, the method 100 illustrates an example of generating encrypted data that can be distributed to other users with particular rights to the data. For example, the method 100 can be utilized to encrypt data that can be distributed through a digital rights management solution.

The method 100 includes a content owner encrypting the content with a data encryption key (DEK) at 102. In these examples, the content owner can be an owner of the data and/or a user that has generated the data. In some examples, the owner of the data can be a user that has legal ownership over the data and/or legal ownership to distribute the data. In this way, the content owner can be a user that intends to protect the data from unauthorized users and distribute the data to authorized users. As used herein, an unauthorized user can be a user or device that does not have a legal right to access the data or a user that has not been authorized by the content owner to access the data.

In some examples, the content owner can utilize a plurality of different types of encryption for encrypting the content or data. For example, the data encryption key can be utilized to convert the content to a cipher or other type of encrypted code such that a different user can decrypt the encrypted code to access the content or data. In this way, only a user with the correct data encryption key (e.g., data encryption key utilized to encrypt the content, etc.) is capable of decrypting or accessing the content.

The method 100 can include the content owner uploading the encrypted content to a storage service at 104. In some examples, a computing device is utilized to upload or transfer the encrypted data to a storage service. As used herein, a storage service is a service provided by an organization for storing data. In some examples, the storage service is a third-party storage provider such as, but not limited to: a cloud service, a remote storage device, a web service, among other storage solutions. The storage service can store the encrypted data for a period of time until the data is requested by an authorized user.

The method 100 can include the content owner splitting the data encryption key (DEK) in two parts at 106. For example, the first part can be identified as data encryption key A (DEKa) and the second part can be identified as data encryption key B (DEKb). In these examples, splitting the data encryption key can include identifying the values (e.g., bits, code, etc.) of the data encryption key and breaking the values into a first set of values and a second set of values such that when the first set of values are coupled to the second set of values, the data encryption key is complete. In this way, encrypted data is not able to be decrypted without having both the DEKa and the DEKb. For example, a user would not be able to decrypt the encrypted content of the content owner with either the DEKa or the DEKb alone. Thus, decryption utilizing DEKa without DEKb will not successfully decrypt the content. In a similar manner, utilizing DEKb without DEKa will not successfully decrypt the content.

As described herein, the DEK can be split into a plurality of additional portions. For example, the method can utilize a first data encryption key (DEKa), a second data encryption key (DEKb), a third data encryption key (DEKc), and/or a fourth data encryption key (DEKd). In this way, the plurality of data encryption keys can be distributed to different users and/or devices without allowing the different users to decrypt the content without all of the data encryption key portions. In a specific example, the DEKa can be provided to a trusted player, the DEKb can be provided to an intermediate trusted player, the DEKc can be provided to an owner of associated content, and the DEKd can be provided to a crypto service. In other examples, the DEK can be split into a plurality of portions that correspond to a quantity of users that are associated with a transaction associated with the encrypted content. For example, four users/devices can be associated with a transaction for the encrypted content. In this example, the DEK can be split into four portions and each portion can be provided to a corresponding user/device of the four users/devices.

The method 100 can include the content owner encrypting DEKa with a cipher text policy at 108. As used herein, a cipher text policy can include a policy where a particular user type or a particular set of credentials is used to determine if a user or device is able to decrypt. For example, the cipher text policy can identify a particular actor type as a “trusted player”. In this way, a particular actor that is identified can be determined to be trusted. The result of the cipher text policy for the DEKa is an encrypted DEKa (EncDEKa). In some examples, the “trusted player” is a device that can utilize the content or data that was encrypted by the DEK. In a specific example, the trusted player is a printing device. In these examples, the printing device can have particular credentials (e.g., unique identification (ID), serial number, manufacturer number, etc.) that can be utilized to determine when the printing device is capable of printing the content and/or distributing the content. In this way, the actor type can be an authorized type of printing device. In these examples, the printing device or trusted player is not able to decrypt the content since the trusted player only has the EncDEKa.

In some examples, the method 100 includes the content owner encrypting the DEKb with a cipher text policy at 110. In some examples, the cipher text policy can be utilized to identify a particular actor type in a similar way as the DEKa, but the actor type is a particular crypto service. The result is an encrypted DEKb (EncDEKb). In this example, the crypto service is a service for providing encrypted data to an end user and/or authorized player. In some examples, the crypto service may not be a trusted entity of the content owner. For this reason, the content owner may not want to provide the crypto service with the ability to decrypt the content. In these examples, the crypto service is not able to decrypt the encrypted content since the crypto service only has the EncDEKb.

The method 100 can include the content owner uploading the EncDEKa and EncDEKb to a BlockChain at 112. As used herein, a BlockChain is a shared, immutable ledger that facilitates the process of recording transactions and tracking assets. In some examples, the BlockChain can be a public ledger of transactions that are performed. In this way, the BlockChain can be utilized to ensure that the content is distributed in a particular manner. For example, the BlockChain can be a public record of transactions for the content such that the content is only distributed a particular quantity of times. In a specific example, the BlockChain can be utilized to ensure that the content is printed by a printing device a particular quantity of times before preventing further printing. In this way, a quantity of copies of particular content can be limited. The BlockChain can be utilized to ensure other aspects of distribution or purchasing are managed.

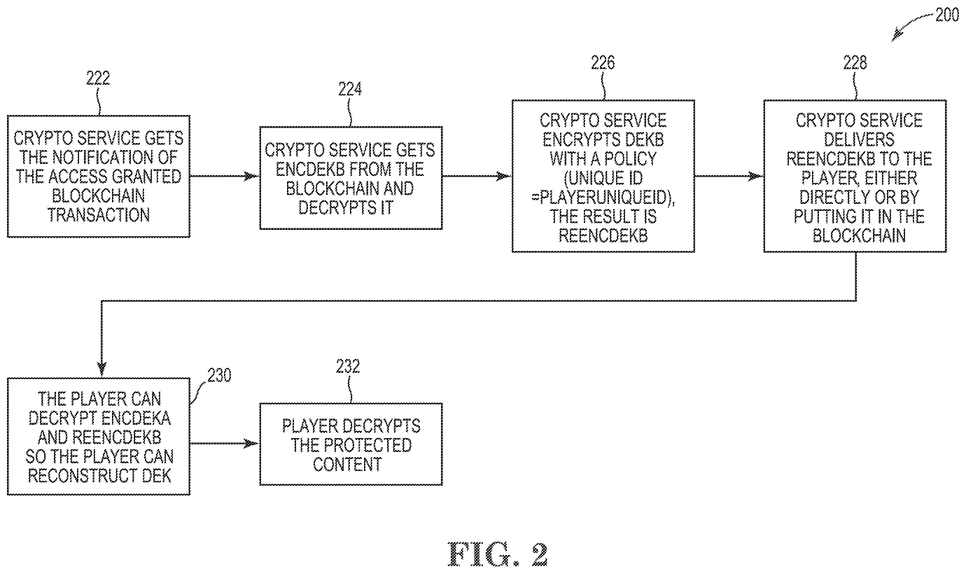

FIG. 2 illustrates an example of a method 200 for executing a data encryption key split. In some examples, the method 200 can be a continuation of method 100 as referenced in FIG. 1. For example, the method 100 can be utilized to generate the encrypted content and encrypted data encryption key portions. The data encryption key portion can be published to the BlockChain that is utilized for recording the transactions associated with the encrypted content. In these examples, method 200 can be utilized to provide the encrypted content to an authorized user. In some examples, the authorized user can utilize the BlockChain to perform a transaction to become an authorized user of the encrypted content (e.g., purchase access to the encrypted content, purchase a printed image of the content, etc.).

The method 200 can include the crypto service receiving a notification of the access granted blockchain transaction at 222. In some examples, the crypto service can be a service that can be available to receive the notification without the content owner being available. In this way, the crypto service can allow a transaction of the content without the content owner being available or being online (e.g., having access to a network, etc.). Thus, a player or purchaser of the content can execute a transaction for the content and the crypto service can initiate the service of the transaction without an interaction of the content owner.

The method 200 can include the crypto service receiving EncDEKb from the BlockChain and decrypting the EncDEKb at 224. As describe herein with reference to method 100 in FIG. 1, the crypto service can have access to the EncDEKb and the key (e.g., credentials of the cipher text, etc.) to decrypt the EncDEKb. In this way, the crypto service has access to DEKb. In some examples, the crypto service can obtain the EncDEKb from the BlockChain instead of storing the EncDEKb or DEKb. In this way, the crypto service is able to obtain an unencrypted version of DEKb through the EncDEKb published to the BlockChain. As described herein, the crypto service is still not able to decrypt the encrypted content without the DEKa or credentials to decrypt the EncDEKa from the BlockChain.

The method 200 can include the crypto service encrypting DEKb with a policy at 226. In some examples, the policy can be a unique identification (ID) or purchase code associated with the player or user that executed the transaction on the BlockChain. The result is a re-encrypted DEKb (ReencDEKb) utilizing the particular policy. In some examples, the ReencDEKb can be decrypted utilizing the unique ID. In some examples, the unique ID of the player can be a serial number of a device, such as a printing device or other type of distribution device. In this way, the player is able to decrypt the ReencDEKb utilizing the device's own serial number or identification number.

The method 200 can include the crypto service delivering the ReencDEKb to the player, either directly or by putting it in the BlockChain at 228. In some examples, the crypto service can provide the ReencDEKb to the player or user that executed the transaction to allow the player to access the DEKb. As described herein, the player can be a printing device or other type of device that can utilize or distribute the content. In some examples, the crypto service can securely provide the ReencDEKb to the player since the ReencDEKb is encrypted utilizing the unique ID of the player.

The method 200 can include the player decrypting the EncDEKa and ReencDEKb to allow the player to reconstruct data encryption key (DEK) at 230. As described herein, the player can be identified as a trusted player. In this way, the player is able to decrypt the EncDEKa utilizing the cipher text policy that was utilized to encrypt the DEKa described in method 100 as referenced in FIG. 1. In this way, the player is able to decrypt the EncDEKa to obtain DEKa. In a similar way, the player is able to utilize the unique ID and corresponding policy to decrypt the ReencDEKb to obtain the DEKb. At this time, the player has the DEKa and DEKb portions of the complete DEK. At this point, the player is able to combine the DEKa and DEKb to obtain the complete DEK for decrypting the content.

The method 200 can include the player decrypting the protected content utilizing the reconstructed data encryption key at 232. As described herein, the player can be a printing device or other type of distribution device that can utilize the content. In these examples, the player is able to decrypt the content utilizing the reconstructed DEK and execute a particular function utilizing the content. For example, the player may be able to print a copy of the content. Although a printing device is utilized in specific examples, other devices that can utilize digital content can be utilized in a similar way. For example, the protected content can include video game data. In this example, the distribution device can be a gaming counsel capable of utilizing the video game data. In this way, the trusted player can be a particular gaming counsel that can provide a unique ID (e.g., serial number, etc.) as described herein. A plurality of mechanical or electrical devices can be utilized as a trusted player. In this way, the functions or specifications of the devices can be utilized to determine if a device is a trusted device or capable of utilizing the encrypted content.

In some examples, the method 200 includes determining when the player is authorized to re-encrypt the DEKa and DEKb. In some examples, the method 200 determines whether the player has been updated or includes particular settings to ensure that the player is capable of re-encrypting without causing a security error. In some examples, the player can split the DEK into DEKa and DEKb. The DEKa and DEKb can be encrypted in a similar way as described in method 100 as referenced in FIG. 1 prior to updating the BlockChain and/or prior to sending the DEKb to the crypto service or content owner.

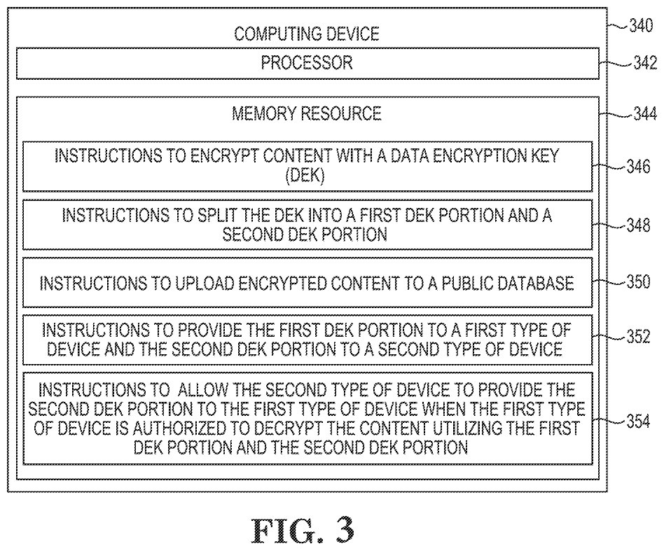

FIG. 3 illustrates an example of a computing device 340 for executing a data encryption key split. The computing device 340 can be a device that can execute the methods described herein. In some examples, the computing device 340 can be one of a plurality of computing devices that are utilized in a computing system to perform the methods of splitting a data encryption key to allow encrypted data to be provided by a crypto service without allowing access to the crypto service.

In some examples the computing device 340 can include a processor 342 (e.g., processor resource, processing resource, etc.) communicatively coupled to a memory resource 344. As described further herein, the memory resource 344 can include instructions 346, 348, 350, 352, 354 that can be executed by the processor 342 to perform particular functions. In some examples, the computing device 340 is coupled to a printing device and/or a network that is communicatively coupled to a printing device.

The computing device 340 can include components such as a processor 342. As used herein, the processor 342 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 346, 348, 350, 352, 354. In other examples, the computing device 340 can include instructions 346, 348, 350, 352, 354, stored on a machine-readable medium (e.g., memory resource 344, non-transitory computer-readable medium, etc.) and executable by a processor 342. In a specific example, the computing device 340 utilizes a non-transitory computer-readable medium storing instructions 346, 348, 350, 352, 354, that, when executed, cause the processor 342 to perform corresponding functions.

In some examples, the computing device 340 can include instructions 346 that can be executed by a processor 342 to encrypt content with a data encryption key (DEK). As described herein, a data encryption key can be a series of values that can be utilized to encrypt data by altering the data based on the values of the data encryption key.

In some examples, the computing device 340 can include instructions 348 that can be executed by a processor 342 to split the DEK into a first DEK portion and a second DEK portion. As described herein, the data encryption key can be split into a first portion (e.g., DEKa) and a second portion (e.g., DEKb). The split data encryption key can include the same values as the complete data encryption key when the first portion and the second portion are reconnected or connected to form the string of values of the original data encryption key. In this way, the first portion of the data encryption key can be a first portion of values from the plurality of values of the data encryption key and the second portion of the data encryption key can be a second portion of values from the plurality of values. In this way, the first portion of values can be aligned with the second portion of values to generate the plurality of values of the data encryption key.

In some examples, the computing device 340 can include instructions 350 that can be executed by a processor 342 to upload encrypted content to a public database. In some examples, the encrypted content can be uploaded to a public database such that a crypto service or other type of service can access the encrypted content even when a content owner is not available. In this way, a transaction can occur to access the encrypted content without the content owner. In some examples, the public database can be a cloud service or remote database. In other examples, the public database can be a BlockChain that is publicly available to a plurality of users.

In some examples, the computing device 340 can include instructions 352 that can be executed by a processor 342 to provide the first DEK portion to a first type of device and the second DEK portion to a second type of device. As described herein, the first portion of the DEK can be provided to a player or potential distribution device and the second portion of the DEK can be provided to a crypto service. In this way, the player and the crypto service may not have access to decrypt the encrypted data. In this way, the encrypted data is protected from the player and protected from the crypto service. In this way, the data can be distributed by the crypto service without having to provide access to the content to the crypto service.

In some examples, the computing device 340 can include instructions 354 that can be executed by a processor 342 to allow the second type of device to provide the second DEK portion to the first type of device when the first type of device is authorized to decrypt the content utilizing the first DEK portion and the second DEK portion. As described herein, the second type of device can be a crypto service device that can receive a notification that the content is to be distributed to a particular player (e.g., authorized player, etc.).

In these examples, the second type of device can receive a unique ID from the authorized player (e.g., first type of device, etc.). The second type of device can encrypt the second DEK portion with the unique ID and send the encrypted second DEK portion to the authorized player. In these examples, the authorized player will be able to decrypt the second DEK portion with the unique ID and utilize the combined first DEK portion and the second DEK portion to generate the original DEK utilized to encrypt the data. In these examples, the first type of device is able to utilize the DEK to decrypt the data and distribute the data.

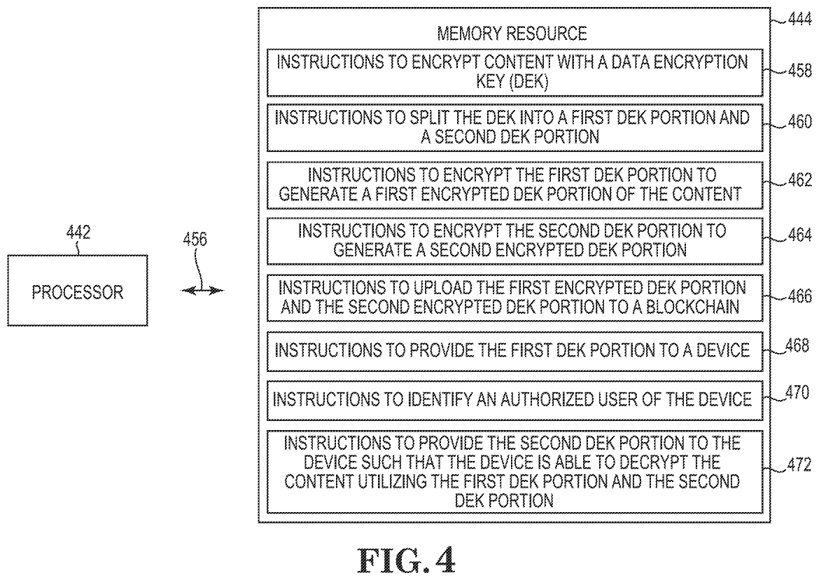

FIG. 4 illustrates an example of a memory resource 444 storing instructions 458, 460, 462, 464, 466, 468, 470, 472 for executing a data encryption key split. In some examples, the memory resource 444 can be a part of a computing device or controller that can be communicatively coupled to a computing system that includes printing devices or other devices that can utilize the data that has been encrypted. For example, the memory resource 444 can be part of a computing device 340 as referenced in FIG. 3 and communicatively coupled to a plurality of devices.

In some examples, the memory resource 444 can be communicatively coupled to a processor 442 that can execute instructions 458, 460, 462, 464, 466, 468, 470, 472 stored on the memory resource 444. For example, the memory resource 444 can be communicatively coupled to the processor 442 through a communication path 456. In some examples, a communication path 456 can include a wired or wireless connection that can allow communication between devices and/or components within a single device or with a plurality of devices.

The memory resource 444 may be electronic, magnetic, optical, or other physical storage device that stores executable instructions. Thus, a non-transitory machine readable medium (MRM) (e.g., a memory resource 444) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine readable medium (e.g., a memory resource 444) may be disposed within a controller and/or computing device. In this example, the executable instructions 458, 460, 462, 464, 466, 468, 470, 472 can be “installed” on the device. Additionally, and/or alternatively, the non-transitory machine readable medium (e.g., a memory resource 444) can be a portable, external or remote storage medium, for example, which allows a computing system to download the instructions 458, 460, 462, 464, 466, 468, 470, 472 from the portable/external/remote storage medium. In this situation, the executable instructions may be part of an “installation package”. As described herein, the non-transitory machine readable medium (e.g., a memory resource 444) can be encoded with executable instructions for a method of encryption that can split the data encryption key to protect data that is provided to a crypto system.

The instructions 458, when executed by the processor 442, can include instructions to encrypt content with a data encryption key (DEK). As described herein, the data encryption key can be utilized to encrypt content utilizing by randomizing the data to prevent unauthorized users from accessing the content. In some examples, the data encryption key is a series of values to determine how to randomize and/or encrypt the content. In this way, users with the data encryption key is able to decrypt the content and utilize the content while users without the data encryption key are not able to decrypt the content.

The instructions 460, when executed by the processor 442, can include instructions to split the DEK into a first DEK portion and a second DEK portion. In some examples, splitting the DEK into a first portion of values and a second portion of values such that combining the first portion of values and the second portion of values generates the plurality of values of the DEK. In this way, the first DEK portion can be provided to a first device and the second DEK portion can be provided to a second device such that neither the first deice or the second device can decrypt the content without the corresponding DEK portion.

The instructions 462, when executed by the processor 442, can include instructions to encrypt the first DEK portion to generate a first encrypted DEK portion. As described herein, the first DEK portion can be encrypted such that an authorized crypto service is able to decrypt the first DEK portion. In this way, the first DEK portion can be securely provided to the crypto service. Thus, the crypto service can decrypt the first DEK encrypted portion to obtain the first DEK portion. However, the crypto service is not able to decrypt the content without the second DEK portion. In addition, since the second DEK portion is encrypted utilizing an authorized player credential, the crypto service is not able to decrypt the second encrypted DEK portion.

The instructions 464, when executed by the processor 442, can include instructions to encrypt the second DEK portion to generate a second encrypted DEK portion. As described herein, the second DEK portion can be encrypted to generate a second encrypted DEK portion that can be published to a BlockChain or public domain. In this way, the first encrypted DEK portion and the second encrypted DEK portion can be published to the BlockChain without allowing access to the content.

The instructions 466, when executed by the processor 442, can include instructions to upload the first encrypted DEK portion and the second encrypted DEK portion of the content to a blockchain. As described herein, the first encrypted DEK portion and the second encrypted DEK portion can be made publicly available, such as in a BlockChain. In this way, the crypto service can access the first encrypted DEK portion from the BlockChain and the device can access the second encrypted DEK portion from the BlockChain.

The instructions 468, when executed by the processor 442, can include instructions to provide the first encrypted DEK portion to a device. In some examples, the first encrypted DEK portion can be provided to a device that is able to distribute the content when the content is decrypted using the DEK. In some examples, the first encrypted DEK portion is provided to the device through access to the BlockChain. In some examples, the device is able to decrypt the first encrypted DEK utilizing device credentials such as a unique ID associated with the device.

The instructions 470, when executed by the processor 442, can include instructions to identify an authorized user of the device. In some examples, the authorized user of the device can be a user that has performed a transaction to access the content. The user can purchase access of the content. In some examples, the authorized user can execute a purchase through the BlockChain that includes the first DEK encrypted portion and the second DEK encrypted portion.

The instructions 472, when executed by the processor 442, can include instructions to provide the second DEK portion to the device such that the device is able to decrypt the content utilizing the first DEK portion and the second DEK portion. In some examples, the second encrypted DEK portion can be decrypted by the crypto service. As described herein, the crypto service can decrypt the second DEK encrypted portion utilizing credentials associated with the crypto service. In these examples, the crypto service can access the second DEK encrypted portion from the BlockChain and decrypt the second DEK encrypted portion. As described herein, the second DEK portion can be encrypted by the crypto service utilizing credentials of the device. In this way, the second DEK portion can be provided to the device securely and the device can decrypt the second DEK portion utilizing the credentials provided to the crypto service to encrypt the second DEK portion.

In some examples, the device is able to combine the first DEK portion and the second DEK portion to generate the DEK. In this way, the device is able to decrypt the content utilizing the DEK. The device may be able to utilize the decrypted content to distribute the content to the authorized user. For example, the device can be a printing device that is able to generate a printed image on a substrate utilizing the decrypted content.

In some examples, the device is authorized to determine when the device is able to encrypt the content and/or the DEK. When the device is authorized, the device encrypts the content with the DEK. The device can then split the DEK into the first DEK portion and second DEK portion. In these examples, the device can encrypt the first DEK portion with the device credentials and encrypt the second DEK portion with the crypto service credentials. In this way, the first encrypted DEK portion and the second encrypted DEK portion can be published to the BlockChain or other type of public domain. In addition, the encrypted content can be provided to a storage device that is accessible by the crypto service.

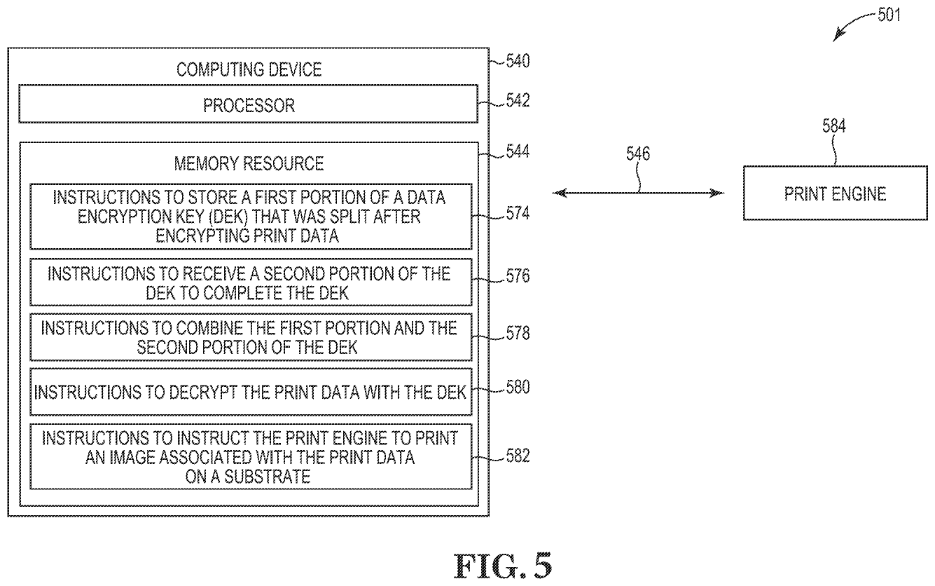

FIG. 5 illustrates an example of a system 501 including a computing device 540 for executing a data encryption key split. In some examples the computing device 540 can be a device that includes a processor 542 communicatively coupled to a memory resource 544. As described herein, the memory resource 544 can include or store instructions 574, 576, 578, 580, 582, that can be executed by the processor 542 to perform particular functions.

The system 501 includes a print engine 584. In some examples, the print engine 584 can be a printing device or printer that can be utilized to generate images on a print medium. In some examples, the computing device 540 can be positioned within the printing device to operate the print engine 584. That is a printing device can include the computing device 540 to instruct the print engine 584 to generate images on a substrate or print medium.

In some examples, the computing device 540 can include instructions 574 that can be executed by a processor 542 to store a first portion of a data encryption key (DEK) that was split after encrypting print data. As described herein, the DEK can be split into a first portion and a second portion after encrypting print data. As used herein, the print data can be content or information that can be utilized to generate an image on a substrate or print medium.

In some examples, the computing device 540 can include instructions 576 that can be executed by a processor 542 to receive a second portion of the DEK to complete the DEK. As described herein, the computing device 540 can receive the second portion of the DEK from a crypto service. In these examples, the second portion of the DEK can be encrypted by the crypto service utilizing a unique ID associated with the computing device 540. In this way, the computing device 540 is able to decrypt the second portion of the DEK from the crypto service utilizing the unique ID.

In some examples, the computing device 540 can include instructions 578 that can be executed by a processor 542 to combine the first portion and the second portion of the DEK. As described herein, the first portion of the DEK can be combined or attached to the second portion of the DEK to generate the original DEK utilized to encrypt the print data. In this way, the computing device 540 can obtain the DEK to decrypt the print data by combining the first portion of the DEK with the second portion of the DEK.

In some examples, the computing device 540 can include instructions 580 that can be executed by a processor 542 to decrypt the print data with the DEK. As described herein, the DEK that is generated utilizing the first portion of the DEK and the second portion of the DEK can be utilized to decrypt the print data.

In some examples, the computing device 540 can include instructions 582 that can be executed by a processor 542 to instruct the print engine 584 to print an image associated with the print data on a substrate. As described herein, the computing device 540 can be part of a printing device that utilizes the print engine 584 to generate images on a substrate based on the print data. In this way, the print data can be decrypted in order to be utilized by the computing device 540 to instruct the print engine 584 to generate an image on the substrate.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A computing device, comprising:
a processor resource; and
a non-transitory memory resource storing machine-readable instructions stored thereon that, when executed, cause the processor resource to:
encrypt content with a data encryption key (DEK);
split the DEK into a first DEK portion and a second DEK portion;
upload encrypted content to a public database;
provide the first DEK portion to a first type of device and the second DEK portion to a second type of device; and
allow the second type of device to provide the second DEK portion to the first type of device when the first type of device is authorized to decrypt the content utilizing the first DEK portion and the second DEK portion.

2. The computing device of claim 1, wherein the processor resource is to:
encrypt the encrypted content with the first DEK portion to generate a first content portion; and
encrypt the encrypted content with the second DEK portion to generate a second content portion.

3. The computing device of claim 1, wherein the content is encrypted with an attribute based encryption policy.

4. The computing device of claim 1, wherein the second type of device is a third party crypto service device to manage access to the encrypted content and the first type of device is a content device to distribute the content.

5. The computing device of claim 1, wherein the first type of device is authorized when the computing device is offline.

6. A non-transitory memory resource storing machine-readable instructions stored thereon that, when executed, cause a processor resource to:
encrypt content with a data encryption key (DEK);
split the DEK into a first DEK portion and a second DEK portion;
encrypt the first DEK portion to generate a first encrypted DEK portion;
encrypt the second DEK portion to generate a second encrypted DEK portion;
upload the first encrypted DEK portion and the second encrypted DEK portion to a blockchain;
provide the first DEK portion to a device;
identify an authorized user of the device; and
provide the second DEK portion to the device such that the device is able to decrypt the content utilizing the first DEK portion and the second DEK portion.

7. The memory resource of claim 6, wherein the processor resource is to instruct the device to encrypt the content when the device is determined to be at a particular security state.

8. The memory resource of claim 7, wherein the processor resource is to provide the second DEK to a crypto service to provide the second DEK portion to the device.

9. The memory resource of claim 7, wherein the processor resource is to identify the authorized user based on credentials provided by the authorized user.

10. The memory resource of claim 6, wherein the content is capable of being decrypted with both the first DEK portion and the second DEK portion.

11. A printing system, comprising:
a print engine to generate images on a substrate based on print data; and
a processor to:
store a first portion of a data encryption key (DEK) that was split after encrypting print data;
receive a second portion of the DEK to complete the DEK;
combine the first portion and the second portion of the DEK;
decrypt the print data with the DEK; and
instruct the print engine to print an image associated with the print data on a substrate.

12. The printing system of claim 11, wherein the first portion of the DEK includes an attribute associated with the printing system.

13. The printing system of claim 11, wherein the processor is to:
encrypt the print data with the DEK after the print engine generates the image on the substrate;
encrypt the encrypted print data with the first portion of the DEK; and
encrypt the encrypted print data with the second portion of the DEK.

14. The printing system of claim 13, wherein the processor is to perform a security analysis of the printing system prior to encrypting the print data with the DEK.

15. The printing system of claim 11, wherein the processor is to:
receive the first portion of the DEK from a controller of the print data; and
receive the second portion of the DEK from a crypto security agent.
